(19) United States
(12) Patent Application Publication
(10) Pub. No.: US 2026/0243236 A1
(43) Pub. Date: Aug. 20, 2026

(54) THERMO-ELECTROCHEMICAL CONVERTER WITH PRESSURE EXCHANGE ENERGY RECOVERY

(71) Applicant: JTEC ENERGY, INC., Atlanta, GA (US)

(72) Inventors: David JOHNSON, Smyma, GA (US); Lonnie G. JOHNSON, Atlanta, GA (US)

(21) Appl. No.: 19/544,320

(22) Filed: Feb. 19, 2026

Related U.S. Application Data
(63) Continuation-in-part of application No. 19/372,684, filed on Oct. 29, 2025.
(60) Provisional application No. 63/760,823, filed on Feb. 20, 2025.
(60) Provisional application No. 63/760,823, filed on Feb. 20, 2025.

(51) Int. Cl. F03G 7/00; F04F 13/00

(52) U.S. Cl. CPC F03G 7/008; F04F 13/00

(57) ABSTRACT

An electrochemical cell includes a working fluid and a membrane electrode assembly having first and second electrodes and a proton-exchange membrane. A first chamber in fluid communication with the first electrode contains the working fluid at a first pressure. A second chamber in fluid communication with the second electrode contains the working fluid at a greater second pressure greater. A first conduit is in fluid communication with the first chamber. A second conduit is in fluid communication with the second chamber. A heating vessel is configured to heat an exchange fluid provided by a third conduit at a third pressure. A fourth conduit is configured to receive the exchange fluid from the heating vessel at a greater fourth pressure. An energy recovery device in fluid communication with the conduits is configured to transfer energy and/or pressure from the exchange fluid to the working fluid.

### CROSS-REFERENCE TO RELATED APPLICATIONS

This application is a continuation-in-part of U.S. Patent Application No. 19/372,684, filed October 29, 2025, entitled “JTEC Heat Engine Using Pressure Exchanger,” currently pending, which claims the benefit of U.S. Provisional Patent Application No. 63/760,823, filed February 20, 2025, entitled “Thermo-electrochemical Converter with Pressure Exchange Energy Recovery,” currently pending. This application also claims the benefit of U.S. Provisional Patent Application No. 63/760,823. The entire contents of all of the above are incorporated by reference herein.

### BACKGROUND

Embodiments described herein relate generally to electrochemical cells, and more particularly, to systems and methods for operating an electrochemical cell using an energy recovery device, such as a pressure exchanger.

The conversion of heat energy or chemical energy to electrical energy, or vice-versa, may be accomplished in a variety of ways. For example, known electrochemical cells or batteries rely on chemical reactions wherein ions and electrons of a reactant being oxidized are transferred to the reactant being reduced via separate paths. Specifically, the electrons are transferred electrically via wiring through an external load where they perform work and the ions are conducted through an electrolyte separator.

However, battery-type electrochemical cells can produce only a limited amount of energy because the confines of the battery casing limit the amount of available reactants that may be contained therein. Although such cells can be designed to be recharged by applying a reverse polarity current/voltage across the electrodes, such recharging requires a separate electrical source. Also, during the recharging process, the cell is typically not usable.

Fuel cells have been developed in an effort to overcome such problems associated with battery-type electrochemical cells. In conventional fuel cells, the chemical reactants are continuously supplied to the electrochemical cell and reaction products are continuously removed. In a manner similar to batteries, fuel cells operate by conducting an ionized species through a selective electrolyte which generally blocks passage of electrons and non-ionized species, such that the electrons have to pass externally through an electrical load to complete the reaction.

The most common type of fuel cell is a proton exchange membrane (PEM) hydrogen-oxygen fuel cell which passes hydrogen through one of the electrodes and oxygen through the other electrode. The hydrogen ions are conducted through a proton conductive electrolyte separator or PEM to the oxygen side of the cell under the voltage potential of the hydrogen-oxygen chemical reaction. Porous electrodes on either side of the electrolyte separator or PEM are used to couple the electrons involved in the chemical reaction through an external load via an external circuit. The electrons and hydrogen ions reconstitute hydrogen in a reaction with oxygen on the oxygen side of the cell for the production of water which is expelled from the system. A continuous electrical current is maintained by a continuous supply of hydrogen and oxygen to the cell.

Mechanical heat engines have also been designed and used to produce electrical power. Mechanical heat engines operate on thermodynamic cycles wherein shaft work is performed using a piston or turbine to compress a working fluid. The compression process is performed at a low temperature and, after compression, the working fluid is raised to a higher temperature. At the high temperature, the working fluid is allowed to expand against a load, such as a piston or turbine, thereby producing shaft work. A key to the operation of all engines employing a working fluid is that less work is required to compress the working fluid at low temperatures than that produced by expanding it at high temperatures. This is the case for all thermodynamic engines employing a working fluid.

For example, steam engines operate on the Rankine thermodynamic cycle, wherein water is pumped to a high pressure, and then heated to steam and expanded through a piston or turbine to perform work. Internal combustion engines operate on the Otto cycle, wherein low-temperature ambient air is compressed by a piston and then heated to very high temperatures via fuel combustion inside the cylinder. As the cycle continues, the expansion of the heated air against the piston produces more work than that consumed during the lower temperature compression part of the cycle.

The Stirling engine has been developed to operate on the Stirling cycle in an effort to provide an engine that has high efficiency and offers greater versatility in the selection of the heat source. The ideal Stirling thermodynamic cycle is of equivalent efficiency to the ideal Carnot cycle, which defines the theoretical maximum efficiency of an engine operating on heat input at high temperatures and heat rejection at low temperatures. However, as with all mechanical engines, the Stirling engine suffers from reliability problems and efficiency losses associated with its mechanical moving parts.

In an effort to avoid the problems inherent with mechanical heat engines, Alkali Metal Thermo-Electrochemical Conversion (AMTEC) cells have been designed as a thermo-electrochemical heat engine. AMTEC heat engines utilize pressure to generate a voltage potential and electrical current by forcing an ionizable working fluid, such as sodium, through an electrochemical cell at high temperatures. The electrodes couple the electrical current to an external load. Electrical work is performed as the pressure differential across the electrolyte separator forces molten sodium atoms through the electrolyte. The sodium is ionized upon entering the electrolyte, thereby releasing electrons to the external circuit. On the other side of the electrolyte, the sodium ions recombine with the electrons to reconstitute sodium upon leaving the electrolyte, in much the same way as the process that occurs in battery and fuel cell type electrochemical cells. The reconstituted sodium, which is at a low pressure and a high temperature, leaves the electrochemical cell as an expanded gas. The gas is then cooled and condensed back to a liquid state. The resulting low-temperature liquid is then re-pressurized. Operation of an AMTEC engine approximates the Rankine thermodynamic cycle.

The heat rejected during cooling and re-condensation of the high temperature expanded gas leaving the electrode at low pressure represents a significant source of entropy loss and therefore AMTEC heat engine inefficiency. AMTEC engines also suffer from reliability issues due to the highly corrosive nature of the alkali metal working fluid. They also have very limited utility. Specifically, AMTEC engines can only be operated at very high temperatures because ionic conductive solid electrolytes achieve practical conductivity levels only at high temperatures. Indeed, even the low-temperature pressurization process must occur at a relatively high temperature, because the alkali metal working fluid must remain above its melt temperature at all times as it moves through the cycle. Mechanical pumps, wicks and even magneto-hydrodynamic pumps have been used to pressurize the low-temperature working fluid.

In an effort to overcome the above-described drawbacks of conventional mechanical and thermo-electrochemical heat engines, the Johnson Thermo-Electrochemical Converter (JTEC) system was developed, as disclosed, for example, in U.S. Patent No. 7,160,639, International Patent Application No. PCT/US2015/044435, and International Patent Application No. PCT/US2016/21508, the entire contents of all of which are incorporated herein by reference.

A JTEC may include a membrane electrode assembly (MEA) formed by a proton-exchange membrane sandwiched between two electrodes to operate on a working fluid. A pressure differential is created across the MEA so that the working fluid ionizes at one electrode. Electrons stripped from the working fluid at the electrode are passed through a circuit to an external load, while the ionized working fluid passes through the proton-exchange membrane to the other electrode. There, the electrons recombine with the ions to reform the working fluid in a lower pressure state. The MEA therefore expands the working fluid during operation. Typically the working fluid will recirculate through some form of compressor (which can be a second MEA in some instances) to bring the working fluid back up to high pressure to begin the cycle anew.

A traditional JTEC requires the MEA and the compressor to share a single working fluid. However, the MEA and the compressor may each have separate ideal operational parameters relating to variables, such as pressure, flowrate, temperature, and working fluid composition. Prior approaches involved using mass exchangers or heat exchangers to try and create separate fluid environments with respect to heat and moisture for both the MEA and the compressor. But heat and mass exchangers are not 100% effective even under ideal conditions. This means that even under the best circumstances, the compressor and the MEA will contain undesirable impurities. This challenge is exacerbated by the fact that heat and mass exchangers are sensitive to off-design operation.

It is desirable to provide a JTEC device that isolates the MEA and the compressor within their own separate fluid loops to enable optimization of each fluid environment without impacting the other, thereby optimizing the overall performance of the JTEC.

### BRIEF SUMMARY

Briefly stated, an example embodiment comprises an electrochemical cell having a working fluid and a membrane electrode assembly (MEA) including a first electrode, a second electrode, and a proton-exchange membrane sandwiched between the first and second electrodes. The first and second electrodes are electrically connected to an external load. A first chamber is in fluid communication with the first electrode and contains the working fluid at a first pressure. A second chamber is in fluid communication with the second electrode and contains the working fluid at a second pressure greater than the first pressure. A first conduit is in fluid communication with the first chamber. A second conduit is in fluid communication with the second chamber. The electrochemical cell further includes an exchange fluid, a heating vessel configured to heat the exchange fluid contained therein, a third conduit in fluid communication with the heating vessel and configured to provide the exchange fluid to the heating vessel at a third pressure, a fourth conduit in fluid communication with the heating vessel and configured to receive the exchange fluid from the heating vessel at a fourth pressure greater than the third pressure, and an energy recovery device in fluid communication with the first, second, third, and fourth conduits and configured to transfer at least one of energy or pressure from the exchange fluid flowing from the fourth conduit to the third conduit to the working fluid flowing from the first conduit to the second conduit.

In one aspect, the energy recovery device is a pressure exchanger. In a further aspect the pressure exchanger is a rotary-type pressure exchanger.

In another aspect, the electrochemical cell further includes a condenser in fluid communication with the third conduit and positioned between the energy recovery device and the heating vessel. The condenser is configured to condense the exchange fluid received from the energy recovery device from a vapor to a liquid. In a further aspect, a pump is configured to move the exchange fluid in the third conduit from the condenser to the heating vessel.

In still another aspect, the heating vessel is a boiler configured to evaporate the exchange fluid for provision to the fourth conduit.

In yet another aspect, the working fluid is hydrogen.

In still another aspect, the exchange fluid is water.

Another example embodiment comprises a method of operating an electrochemical cell including a working fluid, an exchange fluid, a heating vessel, and a membrane electrode assembly (MEA) including a first electrode, a second electrode, and a proton-exchange membrane sandwiched between the first and second electrodes. The method includes operating the MEA, a first chamber in fluid communication with the first electrode containing the working fluid at a first pressure, and a second chamber in fluid communication with the second electrode containing the working fluid at a second pressure greater than the first pressure. The method further includes flowing working fluid from the first chamber to the second chamber via a first conduit in fluid communication with the first chamber and a second conduit in fluid communication with the second chamber and flowing the exchange fluid from a third conduit to a heating vessel and from the heating vessel to a fourth conduit. The third conduit provides the exchange fluid to the heating vessel at a third pressure and the fourth conduit receives the exchange fluid from the heating vessel at a fourth pressure greater than the third pressure. The method further includes transferring at least one of energy or pressure from the exchange fluid flowing from the fourth conduit to the third conduit to the working fluid flowing from the first conduit to the second conduit via an energy recovery device in fluid communication with the first, second, third, and fourth conduits.

In one aspect, the energy recovery device is a pressure exchanger. In a further aspect, the pressure exchanger is a rotary-type pressure exchanger.

In another aspect, the method further includes condensing, by a condenser in fluid communication with the third conduit and positioned between the energy recovery device and the heating vessel, the exchange fluid received from the energy recovery device from a vapor to a liquid. In a further aspect, the method further includes moving, by a pump, the exchange fluid in the third conduit from the condenser to the heating vessel.

In still another aspect, the heating vessel is a boiler, and the method further includes evaporating, by the boiler, the exchange fluid for provision to the fourth conduit.

In yet another aspect, the working fluid is hydrogen.

In still another aspect, the exchange fluid is water.

### BRIEF DESCRIPTION OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

FIG. 1 is a schematic block diagram of an electrochemical cell in accordance with a first example embodiment; and

FIG. 2 is a schematic block diagram of an electrochemical cell in accordance with a second example embodiment.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

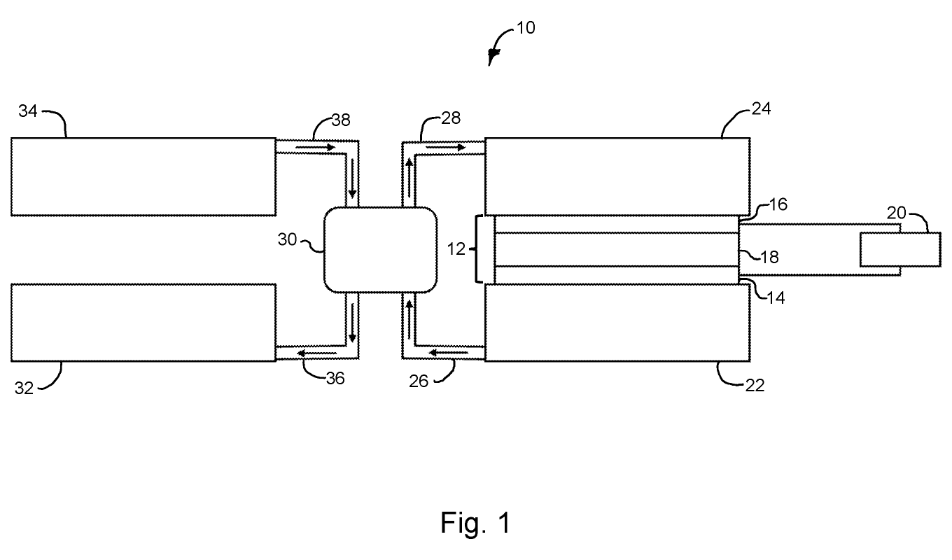

There is shown in FIG. 1 an electrochemical cell 10 in the form of a thermo-electrochemical converter in accordance with a first example embodiment. The thermo-electrochemical converter 10 may be a JTEC device, a hydrogen pump, or the like for converting heat or chemical energy into electrical energy or vice-versa. The thermo-electrochemical converter 10 may operate on an ionizable working fluid that may be expanded and compressed as it traverses the thermo-electrochemical converter 10 during operation. The working fluid may be hydrogen (H₂) gas, although other hydrogen-containing fluids from which the hydrogen may be separated and stored in the manner described below can be used as well.

The thermo-electrochemical converter 10 may include a membrane electrode assembly (MEA) 12 that includes first and second electrodes 14, 16 which may be permeable to the working fluid (or at least hydrogen contained within the working fluid) and a proton-exchange membrane 18 sandwiched between the first and second electrodes 14, 16. The first and second electrodes 14, 16 may be made from suitable materials, such as carbon, ceramic, metal, metalorganic, combinations thereof, or the like and each have a thickness typically ranging from about 10 to about 300 micrometers. The proton-exchange membrane 18 may be made from polymeric material, ceramic material, combinations thereof, or the like, and may have a thickness typically ranging from about 10 to about 300 micrometers. Although one MEA 12 is shown in FIG. 1, any number of MEAs 12 may be arranged together to form a “stack.”

The MEA 12 may be electrically connected to an external load 20. In operation, electrons are stripped from the working fluid or hydrogen at the interface of the second electrode 16. The resulting ions (e.g., protons (H⁺) or other ions) are conducted through the proton-exchange membrane 18 toward the first electrode 14. Electrons flow in the circuit from the second electrode 16, through the load 20, and are supplied to the first electrode 14, where they recombine with the conducted ions to reconstitute the working fluid or hydrogen therein.

A first chamber 22 may be provided in fluid communication with the first electrode 14 and may contain the working fluid at a first pressure, which may be between about 0.1 and about 2 bar (absolute), although other pressure values for the first chamber 22 may be used, as desired. A second chamber 24 may be provided in fluid communication with the second electrode 16 and may contain the working fluid at a second pressure that is greater than the first pressure. The second pressure may be between about 1 and about 50 bar (absolute), although other pressure values may be used for the second chamber 24, as desired. A ratio of the second pressure to the first pressure is preferably between about 2:1 and about 25:1, more preferably at about 20:1, although other pressure ratios may be utilized depending on the configurations and needs of the system. The MEA 12 therefore serves to generate electrical current through expansion of the working fluid (or hydrogen therein) from the second chamber 24 to the first chamber 22.

A first conduit 26 may be provided in fluid communication with the first chamber 22 and a second conduit 28 may be provided in fluid communication with the second chamber 24 to create a flow loop of the working fluid between the first and second chambers 22, 24. The first and second conduits 26, 28 may also be in fluid communication with an energy recovery device 30, such as a pressure exchanger or the like, as will be explained in further detail below, to transfer at least one of energy or pressure to the working fluid as it flows from the first conduit 26 to the second conduit 28.

The electrochemical cell 10 may include a separate fluid loop for increasing the pressure in the working fluid moving from the first chamber 22 to the second chamber 24. Thus, an exchange fluid may be provided, which can be of the same type of fluid as the working fluid, although the fluids may also differ. In one example embodiment, the working fluid may be hydrogen gas or contain hydrogen along with impurities, such as moisture, acid, or the like, in order to optimize performance of the MEA 12. The exchange fluid may be a high purity hydrogen gas to optimize performance of the compression side of the electrochemical cell 10. However, the nature of the exchange fluid is not so limited and other types of exchange fluids, such as water or the like, can be used as well.

The compression side of the electrochemical cell 10 may include a first container 32 containing the exchange fluid at a third pressure, which may be at about 1 PSIA, although other pressure values for the first container 32 may be used, as desired. A second container 34 may contain the exchange fluid at a fourth pressure that is greater than the third pressure. The fourth pressure may be at about 1000 PSIA, although other pressure values may be used for the second container 34, as desired. A ratio of the fourth pressure to the third pressure is preferably at about 1000:1, although other pressure ratios may be utilized depending on the configurations and needs of the system.

In one example embodiment, the first and second containers 32, 34 may be pressure vessels respectively containing metal hydride powder beds that may desorb or absorb hydrogen. For example, the first and second containers 32, 34 may be a prefabricated seamless cylinders, filled with metal hydride and conductive structures through an engineered loading aperture. In other embodiments, the first and second containers 32, 34 may be manufactured in two sections that are welded together after insertion of the metal hydride and thermal structures. In still other embodiments, the first and second containers 32, 34 may be fabricated by spinning or forming around internal structures, ensuring precise integration of heat transfer components. Other vessel types may be used as well, with each vessel configuration being adapted for specific use cases including stationary energy storage, portable hydrogen supply, on-board vehicular hydrogen storage, other types of stored fluids, or the like. The first container 32 may be thermally coupled to a heat sink (not shown) to maintain appropriate temperatures to allow the metal hydride powder to absorb hydrogen, while the second container 34 may be thermally coupled to a heat source (not shown) to maintain appropriate temperatures to allow the metal hydride powder to desorb hydrogen. Heat input and/or rejection may take place via one or more heat transfer fluids (not shown), air, or the like.

The metal hydride may include transition metals, rare earth alloys, intermetallic compounds, nanostructured composites, or the like. In one example embodiment, the metal hydride may have gravimetric capacity of at least about 1-7% hydrogen, a volumetric density greater than compressed hydrogen at about 350 bar, absorption kinetics permitting charging in less than about one hour, reversibility over at least about 100-1000 hydriding/dehydriding cycles with less than 20% loss of capacity, and tolerance to impurities (e.g., carbon monoxide, carbon dioxide, water vapor, and the like). However, the metal hydride may have different characteristics depending on the application and operating conditions. In some embodiments, catalytic additives may be incorporated to enhance kinetics, while binders or coatings may be applied to improve particle durability. In some embodiments, the metal hydride powder may be made from AB5-based compounds, which are advantageous due to being inert. The specific alloy may be chosen to correlate with the operating pressures and temperatures. However, other compound types may be used as well.

Although the first and second containers 32, 34 are described above as being vessels containing metal hydride material, the containers are not so limited and other types of storage containers and/or storage media may be used as well for transferring and/or receiving fluids at varying pressures.

The compression fluid loop may further include a third conduit 36 in fluid communication with the first container 32 and a fourth conduit 38 in fluid communication with the second container 34, thereby allowing the exchange fluid to flow from the higher pressure second container 34 to the lower pressure first container 32. The third and fourth conduits 36, 38 may also be in fluid communication with the energy recovery device 30. In embodiments where the energy recovery device 30 is a pressure exchanger such as in FIG. 1, the pressure exchanger 30 may be in the form of a rotary-type pressure exchanger, although other types of pressure exchangers may be used as well. The pressure exchanger 30 may be configured to transfer pressure from the exchange fluid flowing from the fourth conduit 38 to the third conduit 36 to the working fluid flowing from the first conduit 26 to the second conduit 28. Other similar types of energy recovery devices may be used, as well, for example turbines or the like, to transfer at least one of energy or pressure from the exchange fluid to the working fluid.

In operation, the MEA 12 may operate to generate electricity for the external load 20 via expanding the high pressure working fluid from the second chamber 24. Reconstituted working fluid from the MEA 12 reactions may be flowed back to the second chamber 24 from the first chamber 22 via the first and second conduits 26, 28. At the same time, the exchange fluid may be flowed from the second container 34 to the first container 32 via the third and fourth conduits 36, 38. The pressure exchanger 30 transfers the pressure from the exchange fluid flowing from the fourth conduit 38 to the third conduit 36 to the working fluid flowing from the first conduit 26 to the second conduit 28.

In one example embodiment wherein the first and second containers 32, 34 utilize metal hydride material to store hydrogen as the exchange fluid, the second container 34 may initially be “full” of hydrogen, for example the hydrogen may constitute between about 0.9-1.1 wt% of the total metal hydride mass within the second container 34. Conversely, the first container 32 may initially be “empty” of hydrogen – e.g., the hydrogen may constitute between about 0.1-0.3 wt% of the total metal hydride mass within the first container 32. However, other initial ratios may be used as well. Heat from the heat source may raise the temperature of the metal hydride in the second container 34, causing the metal hydride to desorb hydrogen to establish equilibrium pressure defined by its Pressure-Composition-Temperature (PCT) curve. The desorbed hydrogen may proceed to the pressure exchanger 30, where the hydrogen is expanded to compress the working fluid in the first conduit 22.

When the second container 34 is “empty” of the exchange fluid (i.e., the second container 34 can no longer supply the exchange fluid at a pressure sufficient to accomplish compression of the working fluid in the pressure exchanger 30), the second container 34 may be removed and replaced by another, which may, in some embodiments, be the first container 32 that has received the exchange fluid during operation. Similarly, the second container 34, which has exhausted its working fluid supply, may take the place of the first container 32. In some embodiments, heat may be exchanged between the first and second containers 32, 34 during the position swap to increase efficiency. However, in other embodiments, additional containers (not shown) may be provided so that each of the first and second containers 32, 34 may be replaced with containers that are immediately ready for operation, thereby reducing dead time of the exchange. Removal and replacement may be a manual process or may be automated and performed by a controller (not shown) configured to operate valves and/or other connectors for changing containers.

Although only one of each of the first and second containers 32, 34 are shown in fluid communication with the pressure exchanger 30 at one time, multiple containers may be utilized. For example, multiple second containers 34 may generally simultaneously supply exchange fluid to the pressure exchanger 30, and multiple first containers 32 may generally simultaneously receive the reduced pressure exchange fluid.

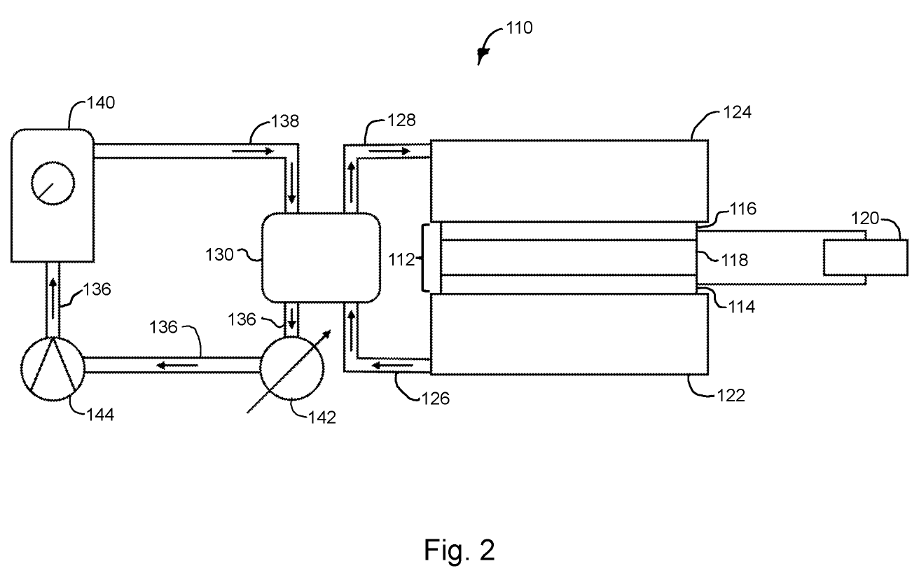

FIG. 2 shows a second example of an electrochemical cell 110, which may include elements similar to those described above for the electrochemical cell 10 in FIG. 1. Therefore, like numerals have been used for the electrochemical cell 110, except the 100 series numerals have been used. Accordingly, a complete description of the electrochemical cell 110 shown in FIG. 2 has been omitted, with mainly the differences being described.

The main difference for the electrochemical cell 110 in FIG. 2 is the form of the compression loop. The compression loop may include a heating vessel 140 that is configured to heat the exchange fluid, so as to increase the pressure thereof. The heating vessel 140 may be provided with the exchange fluid at the third pressure by the third conduit 136 in fluid communication therewith. The third pressure in such embodiments may be about 0.5 PSIA, although other pressure values may be used as well. The fourth conduit 138 may be in fluid communication with the heating vessel 140 and configured to receive the exchange fluid from the heating vessel 140 at the fourth pressure (greater than the third pressure) for delivery to the energy recovery device 130 (e.g., a pressure exchanger or the like). The fourth pressure in such embodiments may be about 1000 PSIA, although other pressure values may be used as well. A ratio of the fourth pressure to the third pressure is preferably at about 2000:1, although other pressure ratios may be utilized depending on the configurations and needs of the system.

The heating vessel 140 may receive heat input from one or more internally-contained heating elements (not shown), such as resistive heating elements, burners, combinations thereof, or the like. Alternatively, heat input may be received from external sources (not shown), including receipt of heat exchange fluids, air heating, geothermal heating, combinations thereof, or the like. In the embodiment shown in FIG. 2, the heating vessel 140 may be a boiler. The exchange fluid may be provided as a phase-change fluid. The boiler 140 may, therefore, be configured to evaporate the exchange fluid for provision to the fourth conduit 138 so that the exchange fluid enters the energy recovery device 130 as a gas. In the embodiment of FIG. 2, the exchange fluid may be water (which the boiler 140 converts to its vapor phase for the pressure exchange), although other types of fluids with similar or lower boiling points, such as certain organic fluids or the like, may be used as well.

In some embodiments, the transfer of energy or pressure to the working fluid by the energy recovery device 130 may be sufficient to transition the exchange fluid back to its liquid phase. However, in some embodiments, such as the one shown in FIG. 2, a condenser 142 may be provided in fluid communication with the third conduit 136 and positioned between the energy recovery device 130 and the heating vessel 140. The condenser 142 may be configured to condense the exchange fluid back to its liquid phase from the vapor phase prior to delivery to the heating vessel 140. The condenser 142 may be of the shell-and-tube type or of other types, which may be selected based on the nature of the exchange fluid, the temperatures and pressures utilized in the loop, and other like variables. The condenser 142 may be connected to a heat sink (not shown) or similar component for transferring heat away from the exchange fluid. In some embodiments, the condenser 142 may conduct heat to a heat exchange fluid. In still further embodiments, the heat exchange fluid may flow between the heating vessel 140 and the condenser 142 to recycle heat extracted at the condenser 142 back to the heating vessel 140 for heating the exchange fluid therein.

A pump 144 may also be provided and configured to move the exchange fluid in the third conduit 136 to the heating vessel 140. In the embodiment shown in FIG. 2, the pump 144 moves the exchange fluid from the condenser 142. However, one or more pumps 144 may be provided irrespective of whether a condenser 142 is required for the exchange fluid. The pump 144 may be a centrifugal pump, a positive displacement pump, or the like. In embodiments where the exchange fluid is in the form of a gas, a blower, fan, or the like (not shown) may be used to move the exchange fluid within the system, as needed.

In operation, the MEA 112 may operate to generate electricity for the external load 120 via expanding the high pressure working fluid from the second chamber 124. Reconstituted working fluid from the MEA 112 reactions may be flowed back to the second chamber 124 from the first chamber 122 via the first and second conduits 126, 128. At the same time, the exchange fluid may be flowed to and from the heating vessel 140 via the third and fourth conduits 136, 138. The heating vessel 140 may heat the exchange fluid contained therein in order to raise the temperature, and thereby the pressure, of the exchange fluid so that the exchange fluid exits the heating vessel 140 at the fourth pressure. In some embodiments, such as where the heating vessel 140 is a boiler or the like, the heating vessel 140 may heat the exchange fluid to the point of evaporation so that the exchange fluid exits the heating vessel 140 as a gas.

The energy recovery device 130 transfers the energy and/or pressure from the exchange fluid flowing from the fourth conduit 138 to the third conduit 136 to the working fluid flowing from the first conduit 126 to the second conduit 128. Exchange fluid may be returned to the heating vessel 140 at the lower, third pressure for re-heating. In embodiments where the exchange fluid exits the energy recovery device 130 as a gas or at least partially as a gas, the condenser 142 may condense the exchange fluid back to a liquid prior to returning the exchange fluid to the heating vessel 140. Return of the exchange fluid to the heating vessel 140 may be aided by the pump 144 or similar fluid handler, where necessary.

Using the arrangements described herein, the disadvantages of the prior approaches can be minimized as the chemical and physical fluid properties of the compression and expansion sides of the electrochemical cell are divorced from each other. In this way, there is no opportunity for impurity transfer due to mass exchanger ineffectiveness or otherwise since the pressure exchanger may function as a barrier to exchange of fluid chemical, compositional, or physical properties.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein.

We claim:

1. An electrochemical cell comprising:
a working fluid;
a membrane electrode assembly (MEA) including a first electrode, a second electrode, and a proton-exchange membrane sandwiched between the first and second electrodes, the first and second electrodes being electrically connected to an external load;
a first chamber in fluid communication with the first electrode and containing the working fluid at a first pressure;
a second chamber in fluid communication with the second electrode and containing the working fluid at a second pressure greater than the first pressure;
a first conduit in fluid communication with the first chamber;
a second conduit in fluid communication with the second chamber;
an exchange fluid;
a heating vessel configured to heat the exchange fluid contained therein;
a third conduit in fluid communication with the heating vessel and configured to provide the exchange fluid to the heating vessel at a third pressure;
a fourth conduit in fluid communication with the heating vessel and configured to receive the exchange fluid from the heating vessel at a fourth pressure greater than the third pressure; and
an energy recovery device in fluid communication with the first, second, third, and fourth conduits and configured to transfer at least one of energy or pressure from the exchange fluid flowing from the fourth conduit to the third conduit to the working fluid flowing from the first conduit to the second conduit.

2. The electrochemical cell of claim 1, wherein the energy recovery device is a pressure exchanger.

3. The electrochemical cell of claim 2, wherein the pressure exchanger is a rotary-type pressure exchanger.

4. The electrochemical cell of claim 1, further comprising a condenser in fluid communication with the third conduit and positioned between the energy recovery device and the heating vessel, the condenser being configured to condense the exchange fluid received from the energy recovery device from a vapor to a liquid.

5. The electrochemical cell of claim 4, further comprising a pump configured to move the exchange fluid in the third conduit from the condenser to the heating vessel.

6. The electrochemical cell of claim 1, wherein the heating vessel is a boiler configured to evaporate the exchange fluid for provision to the fourth conduit.

7. The electrochemical cell of claim 1, wherein the working fluid is hydrogen.

8. The electrochemical cell of claim 1, wherein the exchange fluid is water.

9. A method of operating an electrochemical cell including a working fluid, an exchange fluid, a heating vessel, and a membrane electrode assembly (MEA) including a first electrode, a second electrode, and a proton-exchange membrane sandwiched between the first and second electrodes, the method comprising:
operating the MEA, a first chamber in fluid communication with the first electrode containing the working fluid at a first pressure, and a second chamber in fluid communication with the second electrode containing the working fluid at a second pressure greater than the first pressure;
flowing working fluid from the first chamber to the second chamber via a first conduit in fluid communication with the first chamber and a second conduit in fluid communication with the second chamber;
flowing the exchange fluid from a third conduit to a heating vessel and from the heating vessel to a fourth conduit, the third conduit providing the exchange fluid to the heating vessel at a third pressure and the fourth conduit receiving the exchange fluid from the heating vessel at a fourth pressure greater than the third pressure; and
transferring at least one of energy or pressure from the exchange fluid flowing from the fourth conduit to the third conduit to the working fluid flowing from the first conduit to the second conduit via an energy recovery device in fluid communication with the first, second, third, and fourth conduits.

10. The method of claim 9, wherein the energy recovery device is a pressure exchanger.

11. The method of claim 10, wherein the pressure exchanger is a rotary-type pressure exchanger.

12. The method of claim 9, further comprising condensing, by a condenser in fluid communication with the third conduit and positioned between the energy recovery device and the heating vessel, the exchange fluid received from the energy recovery device from a vapor to a liquid.

13. The method of claim 12, further comprising moving, by a pump, the exchange fluid in the third conduit from the condenser to the heating vessel.

14. The method of claim 9, wherein the heating vessel is a boiler, the method further comprising evaporating, by the boiler, the exchange fluid for provision to the fourth conduit.

15. The method of claim 9, wherein the working fluid is hydrogen.

16. The method of claim 9, wherein the exchange fluid is water.
